(19) United States
(12) Patent Application Publication
(10) Pub. No.: US 2024/0192323 A1
(43) Pub. Date: Jun. 13, 2024

(54) LASER RANGING DEVICE

(71) Applicant: SUTENG INNOVATION TECHNOLOGY CO., LTD., Shenzhen (CN)

(72) Inventors: Jiachao ZHANG, Shenzhen (CN); Hongju LI, Shenzhen (CN); Peng WANG, Shenzhen (CN)

(73) Assignee: SUTENG INNOVATION TECHNOLOGY CO., LTD., Shenzhen (CN)

(21) Appl. No.: 18/536,185

(22) Filed: Dec. 11, 2023

(30) Foreign Application Priority Data
Dec. 12, 2022 (CN) 202211602470.6

(51) Int. Cl. G01S 7/481; G01S 17/08

(52) U.S. Cl. CPC G01S 7/4813; G01S 7/4814; G01S 7/4816; G01S 17/08

(57) ABSTRACT

This application discloses a laser ranging device, including a housing, a light-transmitting sheet, at least one laser emission module, and at least one laser receiving module; the laser emission module includes a laser and an emission lens module; the emission lens module includes at least one emission optical element; the laser receiving module includes a laser detector and a receiving lens module; the receiving lens module includes at least one receiving optical element; the laser receiving module also includes a first enclosing member; and the first enclosing member is arranged between a first optical element and the light-transmitting sheet to enclose and form a first sealing cavity between the light-transmitting sheet and the first optical element; or the second enclosing member is arranged between a second optical element and the light-transmitting sheet to enclose and form a second sealed cavity between the light-transmitting sheet and the second optical element.

### CROSS-REFERENCE TO RELATED APPLICATION

The present application claims the benefit of priority to Chinese Patent Application No. 202211602470.6, filed on Dec. 12, 2022, which is hereby incorporated by reference in its entirety.

### TECHNICAL FIELD

This application relates to the technical field of laser ranging, and in particular to a laser ranging device.

### TECHNICAL BACKGROUND

A laser ranging device is a radar system that emits a laser beam to detect a position, a speed, and other characteristics of a target. The laser ranging device usually includes a housing, a laser emission module, and a laser receiving module. The housing of the laser ranging device is usually assembled with a light-transmitting sheet for allowing light to pass through. The light-transmitting sheet and the housing are assembled to form an accommodating cavity for accommodating an internal element. The laser emission module is arranged inside the accommodating cavity and configured to emit an outgoing laser beam into a detection region. The laser receiving module is arranged in the accommodating cavity and configured to receive an echo laser beam that is reflected back from an object in the detection region, and output an echo electrical signal. The laser ranging device processes the echo electrical signal to obtain parameters such as a distance, azimuth, a height, a speed, an attitude, and a shape of the object in the detection region, thereby realizing a detection function.

Circuit elements included in the laser ranging device, such as a laser in a laser emission module and a detector in the laser receiving module, generate heat in a working process, which leads to an increase in a temperature of the water vapor inside the housing. When flowing onto the light-transmitting sheet, the water vapor at a higher temperature inside the housing is prone to form condensation on a surface of the light-transmitting sheet after the water vapor is cooled, thereby affecting detection performance of the laser ranging device.

### SUMMARY

Embodiments of this application provides a laser ranging device, which can effectively prevent water vapor at a higher temperature from forming condensation on the surface of a light-transmitting sheet when the water vapor is cooled, thereby affecting the detecting performance of the laser ranging device.

A laser ranging device includes a housing, a light-transmitting sheet, at least one laser emission module, and at least one laser receiving module. The light-transmitting sheet is connected to the housing to form an accommodating cavity. The laser emission module is located in the accommodating cavity and includes a laser and an emission lens module. The emission lens module is arranged between the laser and the light-transmitting sheet and includes at least one emission optical element. The laser receiving module is arranged within the accommodating cavity and includes a laser detector and a receiving lens module. The receiving lens module is arranged between the laser detector and the light-transmitting sheet and includes at least one receiving optical element. The laser receiving module also includes a first enclosing member. The first enclosing member is arranged between a first optical element and the light-transmitting sheet, has one end hermetically connected to the light-transmitting sheet, and has the other end hermetically connected to the first optical element to enclose and form a first sealing cavity between the light-transmitting sheet and the first optical element. The first optical element is the receiving optical element closest to the light-transmitting sheet; and/or, the laser emission module also includes a second enclosing member. The second enclosing member is provided between a second optical element and the light-transmitting sheet, has one end hermetically connected to the light-transmitting sheet, and has the other end hermetically connected to the second optical element to enclose and form a second sealing cavity between the light-transmitting sheet and the second optical element. The second optical element is an emission optical element closest to the light-transmitting sheet.

The laser ranging device provided in an embodiment of this application forms a separate first sealing cavity between the first optical element of the receiving lens module closer to the light-transmitting sheet and the light-transmitting sheet via the first enclosing member, which achieves the effect of isolating a water vapor. It is difficult for the water vapor to form condensation in the region of the light-transmitting sheet corresponding to the receiving lens module, which effectively reduces the chances that the detected echo beam affected by the condensation moisture further affects the distance-measuring performance of the laser ranging device. The laser ranging device provided in an embodiment of this application forms a separate second sealing cavity between the second optical element of the emission lens module closer to the light-transmitting sheet and the light-transmitting sheet via the second enclosing member, which achieves the effect of isolating the water vapor. It is difficult for the water vapor to form the condensation moisture in the region of the light-transmitting sheet corresponding to the emission lens module, which effectively reduces the chances that the detected beam affected by the condensation moisture further affects the distance-measuring performance of the laser ranging device. The first enclosing member and the second enclosing member can block the water vapor in a protection cavity from being conveyed to the first sealing cavity and the second sealing cavity. As the volume of the first sealing cavity and of the second sealing cavity is much smaller than the volume of the accommodating cavity, the water vapor in the first sealing cavity and the second sealing cavity is very little, that is, “a raw material” that can form the condensation moisture in the first sealing cavity and the second sealing cavity is less, which effectively reduces a condensation phenomenon of air on the inner side of the light-transmitting sheet, the outgoing side of the emission lens module, and the incident side of the receiving lens module. Therefore, even when the laser ranging device is located in an extreme environment at a lower temperature and a higher humidity, it is difficult to form a condensation phenomenon on the inner side of the light-transmitting sheet, the outgoing side of the emission lens module, and the incident side of the receiving lens module due to the less amount of the water vapor in the first sealing cavity and the second sealing cavity and the isolation of the water vapor from an outer water vapor, which can effectively prevent the water vapor at a higher temperature from forming condensation on the surface of the light-transmitting sheet, thereby further affecting the detection performance of the laser ranging device.

### BRIEF DESCRIPTION OF DRAWINGS

To explain examples of this application more clearly, the following briefly introduces the drawings that need to be used in the embodiments. The drawings in the following description are only some examples of this application.

FIG. 1 is a structural schematic diagram of a laser ranging device according to an embodiment of the present application;

FIG. 2 is an enlarged schematic diagram at A in FIG. 1;

FIG. 3 is an enlarged schematic diagram at A1 in FIG. 2;

FIG. 4 is an enlarged schematic view at B in FIG. 1;

FIG. 5 is an enlarged schematic view at B1 in FIG. 4;

FIG. 6 is an enlarged schematic diagram at C in FIG. 1;

FIG. 7 is an enlarged schematic diagram at C1 in FIG. 6;

FIG. 8 is a schematic cross-sectional view along a direction D-D in FIG. 1;

FIG. 9 is an enlarged schematic diagram at D1 in FIG. 8;

FIG. 10 is a schematic cross-sectional view along a direction E-E in FIG. 1; and

FIG. 11 is an enlarged schematic diagram at E1 in FIG. 10;

FIG. 12 is an enlarged schematic diagram at F in FIG. 1;

FIG. 13 is a top view of a first enclosing member and a second enclosing member in FIG. 1; and

FIG. 14 is a schematic diagram of connection between another laser emission module and a laser receiving module and a light-transmitting sheet according to an embodiment of this application.

### REFERENCE SIGNS

10—housing; 11—first housing; 111—first plate surface; 112—second plate surface; 113 second engaging edge; 114—third engaging edge; 115—first mounting hole; 116—second mounting hole; 12—second housing; 121—fourth engaging edge; 20—light-transmitting sheet; 21 first engaging edge; 22—first light-transmitting sheet; 23—second light-transmitting sheet; 24 third housing; 241—first accommodation hole; 242—second accommodation hole; 30—laser emission module; 31—laser; 32—emission lens module; 321—second optical element; 321a—second outgoing surface; 321b—second sidewall; 322—second lens barrel; 322a—second top wall; 322b—second bottom wall; 322c1 second inner wall; 322c1—second bearing part; 322d—second outer wall; 322e—second assembly space; 322f—seventh through hole; 322g—eighth through hole; 33—second enclosing member; 331—second inner wall surface; 331a—second sealing part; 331b—second connecting part; 331c1 second light-blocking part; 331c1—second light-blocking groove; 331c2—fifth light-blocking wall surface; 331c3—sixth light-blocking wall surface; 332—third end surface; 333—fourth end surface; 334—second accommodating space; 335—fifth through hole; 336—sixth through hole; 34—third sealing connecting structure; 341—fourth sealing bulge; 342—fourth sealing groove; 343—fourth sealing rubber ring; 35—fourth sealing connecting structure; 351—fifth sealing groove; 352—fifth sealing rubber ring; 361—sixth sealing groove; 362—sixth sealing rubber ring; 40—laser receiving module; 41—laser detector; 42—receiving lens module; 421—first optical element; 421a—first incident surface; 421b—first sidewall; 422 first lens barrel; 422a—first top wall; 422b—first bottom wall; 422c1 first inner wall; 422c—first bearing part; 422d—first outer wall; 422e—first assembly space; 422f—third through hole; 422g—fourth through hole; 43—first enclosing member; 431—first inner wall surface; 431a—first sealing part; 431b—first connecting part; 431c1 first light-blocking part; 431c1—first light-blocking groove; 431c2—first light-blocking wall surface 431c3—second light-blocking wall surface; 431c4—third light-blocking wall surface; 431c5—fourth light-blocking wall surface; 432 first end surface; 433—second end surface; 434—first accommodating space; 435—first through hole; 436—second through hole; 44—first sealing connecting structure; 441—first sealing bulge; 442—first sealing groove; 443—first sealing rubber ring; 45—second sealing connecting structure; 451—second sealing groove; 452—second sealing rubber ring; 461—third sealing groove; 462—third sealing rubber ring; 51—accommodating cavity; 52—first sealing cavity; 53—second sealing cavity; 61—seventh sealing rubber ring; 62—eighth sealing rubber ring; 71—first connecting groove; 72—first connecting bulge; 73—second connecting groove; and 74—second connecting bulge.

### DETAILED DESCRIPTION

To make the objectives, technical solutions, and advantages of this application more comprehensible, the following further describes this application in detail with reference to accompanying drawings and embodiments.

When being “fastened to,” “disposed on,” or “provided on” another element, an element can be directly or indirectly located on the another element. When being “connected to” another element, an element can be directly or indirectly connected to the another element.

Azimuth or position relationships indicated by terms such as “vertical,” “horizontal,” and so on are based on the azimuth or position relationships shown in the accompanying drawings, are merely relative concepts for each other or are described with reference to a normal use status of the product, and are intended to describe this application and simplify the descriptions, but are not intended to indicate or imply that the specified device or element shall have specific azimuth or be formed and operated in specific azimuth.

The terms of “first,” “second,” “third,” “fourth,” “fifth,” “sixth,” “seventh,” and “eighth” are merely intended for purpose of description, and shall not be understood as an indication or implication of relative importance or implicit indication of the number of indicated technical features. As a result, a feature defined as “first,” “second,” “third,” “fourth,” “fifth,” “sixth,” “seventh,” and “eighth” can expressly or implicitly include one or more of such features.

In the description of this application, “multiple” means “two or more than two”, unless otherwise clearly and specifically defined. “A and/or B” includes three cases: (1) only A is met; (2) only B is met; and (3) both A and B are met. “A or B” includes two cases: (1) only A is met; and (2) only B is met. “A and B” only includes one case: both A and B are met.

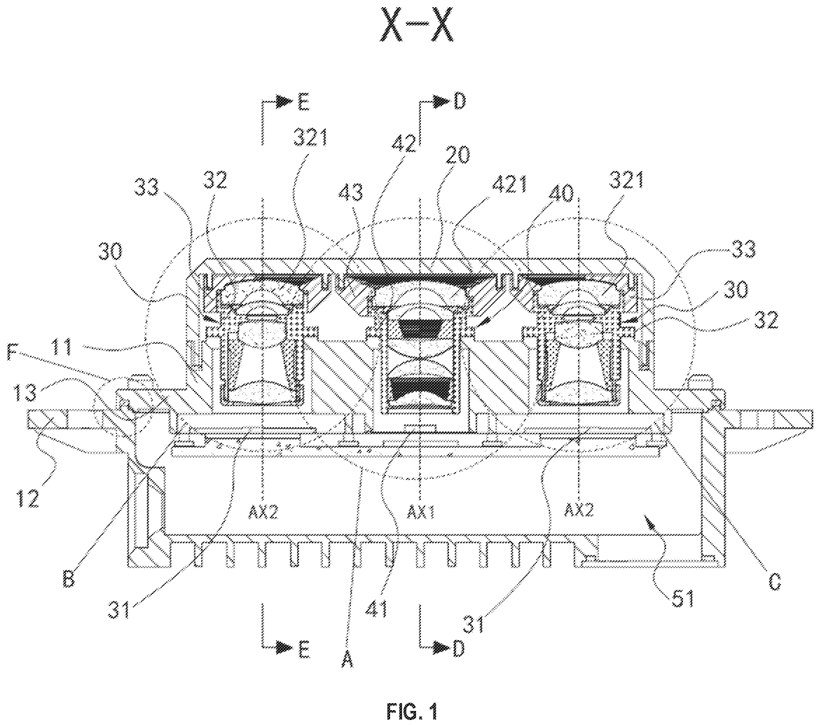

In an embodiment, as shown in FIG. 1, the laser ranging device includes a housing 10, a light-transmitting sheet 20, at least one laser emission module 30, and at least one laser receiving module 40. The laser ranging device is used in the technical field of laser ranging, and the laser ranging device can be LiDAR. The laser emission module 30 is configured to generate a laser beam. The laser beam is configured as a detecting beam to be incident to a target object in a detection region according to a preset detecting angle of view. The laser receiving module 40 is configured to receive an echo beam reflected back from a target object and output an electrical signal corresponding to the echo beam. Then, a signal processing device appropriately processes the electrical signal corresponding to the echo beam to form a point cloud map. By processing the point cloud map, a distance, an azimuth, a height, a speed, an attitude and a shape and other parameters of the target object can be obtained, thus realizing a laser-beam detection function, which can be applied to navigation avoidance, obstacle recognition, ranging, speed measurement, autonomous driving and other scenarios of an automobile, a robot, a logistics vehicle, a patrol vehicle and other products.

The light-transmitting sheet 20 is connected to the housing 10 to form an accommodating cavity 51. The laser emission module 30 and the laser receiving module 40 are located within the accommodating cavity 51. The housing 10 is configured to protect the laser emission module 30 and the laser receiving module 40 and other components. A preparation material of the housing 10 can be a non-light-transmitting material, such as a non-light-transmitting plastic, metal, or resin. The housing 10 can be cylindrical, square cylindrical, or other shapes. The light-transmitting sheet 20 is configured to allow a detecting beam emitted by the laser emission module 30 and the echo beam reflected back from the target object to be emitted out of and emitted into the accommodating cavity 51. The light-transmitting sheet 20 is made of a light-transmitting material. The light-transmitting material can be a light-transmitting glass, a light-transmitting plastic, a light-transmitting resin or the like. The light-transmitting sheet 20 can be a circle, a square, or other shapes. The thickness of the light-transmitting sheet 20 can be selected.

The laser emission module 30 includes a laser 31 and an emission lens module 32. The emission lens module 32 is arranged between the laser 31 and the light-transmitting sheet 20. The emission lens module 32 includes at least one emission optical element. The laser receiving module 40 includes a laser detector 41 and a receiving lens module 42. The receiving lens module 42 is arranged between the laser detector 41 and the light-transmitting sheet 20. The receiving lens module 42 includes at least one receiving optical element. A detecting beam is emitted by the laser 31. The emission lens module 32 receives the detecting beam emitted by the laser 31. The detecting beam is emitted out through the outgoing side of the emission lens module 32. Then, the detecting beam is emitted out of the accommodating cavity 51 through the light-transmitting sheet 20 and incident into the target object. A detecting echo beam reflected back from the target object is incident into the accommodating cavity 51 through the light-transmitting sheet 20 and received by the receiving lens module 42. The receiving lens module 42 emits the detecting echo beam to the laser detector 41 located in the accommodating cavity 51 so that the laser detector 41 receives the detecting echo beam. The laser detector 41 receives the detecting echo beam and then outputs a corresponding electrical signal.

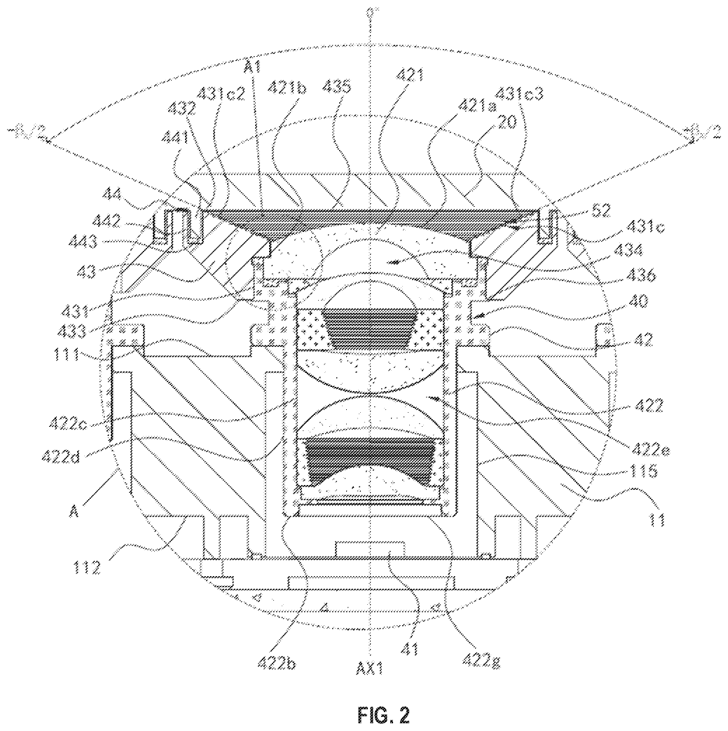

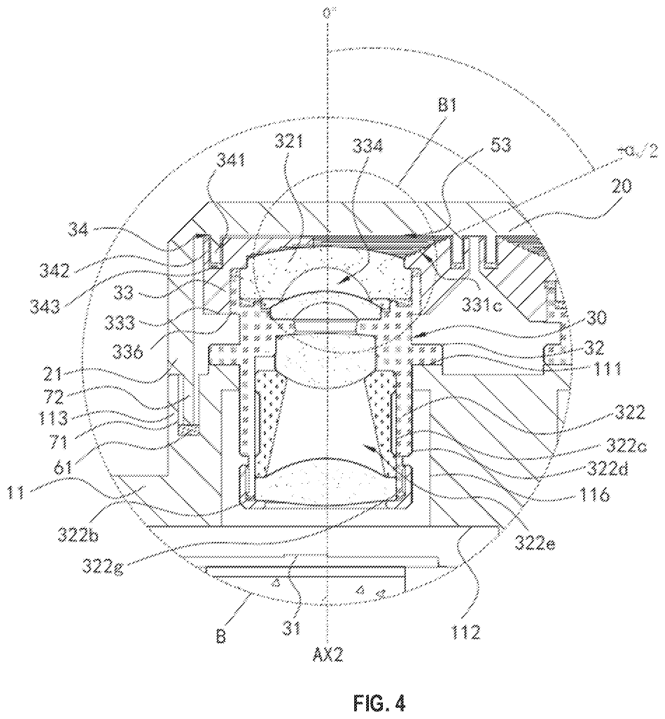

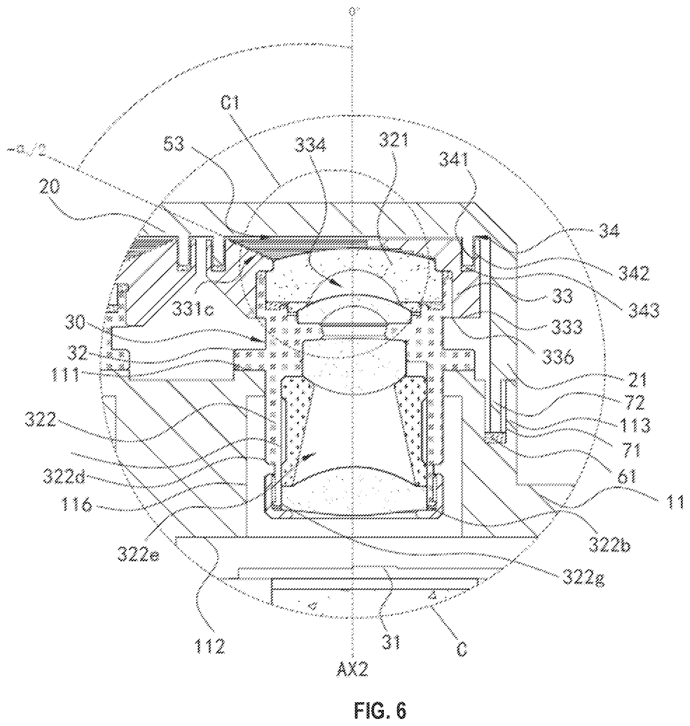

In an embodiment, as shown in FIG. 2, the laser receiving module 40 also includes a first enclosing member 43. The first enclosing member 43 is arranged between a first optical element 421 and the light-transmitting sheet 20, has one end hermetically connected to the light-transmitting sheet 20, and has the other end hermetically connected to the first optical element 421 to enclose and form a first sealing cavity 52 between the light-transmitting sheet 20 and the first optical element 421. The first optical element 421 is the receiving optical element closest to the light-transmitting sheet 20; and/or, as shown in FIG. 4 and FIG. 6, the laser emission module 30 also includes a second enclosing member 33. The second enclosing member 33 is provided between a second optical element 321 and the light-transmitting sheet 20, has one end hermetically connected to the light-transmitting sheet 20, and has the other end hermetically connected to the second optical element 321 to enclose and form a second sealing cavity 53 between the light-transmitting sheet 20 and the second optical element 321. The second optical element 321 is an emission optical element closest to the light-transmitting sheet 20.

The first enclosing member 43 can be provided to form the first sealing cavity 52; or the second enclosing member 33 can be provided to form the second sealing cavity 53. Of course, both the first enclosing member 43 and the second enclosing member 33 can be provided at the same time to form the first sealing cavity 52 and the second sealing cavity 53. At this time, the first sealing cavity 52 and the second sealing cavity 53 are independent of each other and isolated from each other.

As shown in FIG. 1 and FIG. 2, the laser receiving module 40 includes the first enclosing member 43. The first enclosing member 43 is arranged between the first optical element 421 and the light-transmitting sheet 20, has one end hermetically connected to the light-transmitting sheet 20, and has the other end hermetically connected to the first optical element 421 to enclose and form a first sealing cavity 52 between the light-transmitting sheet 20 and the first optical element 421. As shown in FIG. 1, FIG. 4, and FIG. 6, the laser emission module 30 includes the second enclosing member 33. The second enclosing member 33 is provided between the second optical element 321 and the light-transmitting sheet 20, has one end hermetically connected to the light-transmitting sheet 20, and has the other end hermetically connected to the second optical element 321 to enclose and form the second sealing cavity 53 between the light-transmitting sheet 20 and the second optical element 321.

One receiving optical element can be provided in the receiving lens module 42. The plurality of receiving optical elements can also be provided in the receiving lens module 42. At this time, the first optical element 421 is one receiving optical element of the plurality of receiving optical elements closest to the light-transmitting sheet 20. One emission optical element can be provided in the emission lens module 32. The plurality of emission optical elements can also be provided in the emission lens module 32. At this time, the second optical element 321 is one emission optical element of the plurality of emission optical elements closest to the light-transmitting sheet 20. A receiving optical element and an emission optical element are made of a light-transmitting material for allowing transmission of the light ray, and adjusting the light ray, for example, changing a propagation direction of the light ray, changing a light spot form and a light spot size of the light beam consisting of a number of light rays.

The light-transmitting material includes a light-transmitting glass, a light-transmitting plastic, or a light-transmitting resin. The optical element can be at least one of a lens, a light filtering sheet, a uniform light sheet, or other optical elements. The types of the plurality of emission optical elements can also be identical or completely different or partially identical. The types of the plurality of receiving optical elements can be identical or completely different or partially identical. At least one of the emission optical elements included in the emission lens module 32 is a lens. At least one of the receiving optical elements included in the emission lens module 32 is a lens. For example, the plurality of emission optical elements included in the emission lens module 32 can all be the lenses, can include the lenses, and also can include the lenses and the uniform light sheets. When the emission optical element included in the emission lens module 32 includes the lens, the lens can be a convex lens or a concave lens, and can be a spherical lens or an aspheric lens. At least one of the receiving optical elements included in the receiving lens module 42 is the lens. For example, the plurality of receiving optical elements included in the receiving lens module 32 can all be the lenses, or can include the lenses and the light filtering sheets. When the receiving optical element included in receiving lens module 42 includes the lens, the lens can be the convex lens or the concave lens, and can be the spherical lens or the aspheric lens. When the receiving optical element includes a light filtering sheet, the light filtering sheet is adjustable so that the center wavelength of the light filtering sheet matches the actual desired wavelength of the light ray. When the emission optical element includes the uniform light sheet, the uniform light sheet is adjustable so that the spot state of the light beam output by the uniform light sheet matches an actual desired spot morphology.

In an embodiment, taking as an example the following that the portion of the accommodating cavity 51 that does not overlap with the first sealing cavity 52 and the second sealing cavity 53 is a protection cavity, optical devices such as the laser 31 and the laser detector 41 are located in the protection cavity. The incident side (the side of the first optical element 421 closer to the light-transmitting sheet 20) of the receiving lens module 42 is located in the first sealing cavity 52. The outgoing side (the side of the second optical element closer to the light-transmitting sheet 20) of the emission lens module 32 is located in the second sealing cavity 53. The first enclosing member 43 forms the separate first sealing cavity 52 between the first optical element of the receiving lens module 42 closer to the light-transmitting sheet 20 and the light-transmitting sheet 20, which achieves the effect of isolating the water vapor. It is difficult for the water vapor to form the condensation moisture in the region of the light-transmitting sheet 20 corresponding to the receiving lens module 42, which effectively reduces the chances that the detected echo beam affected by the condensation moisture further affects the distance-measuring performance of the laser ranging device. The second enclosing member 33 forms the separate second sealing cavity 52 between the second optical element of the emission lens module 32 closer to the light-transmitting sheet 20 and the light-transmitting sheet 20, which achieves the effect of isolating the water vapor. It is difficult for the water vapor to form the condensation moisture in the region of the light-transmitting sheet 20 corresponding to the emission lens module 32, which effectively reduces the chances that the detected beam affected by the condensation moisture further affects the distance-measuring performance of the laser ranging device.

The heat generated by the laser ranging device in a working process mainly comes from a circuit element in the protection cavity, for example, the laser 31 and the laser detector 41, so that the temperature of the water vapor in the protection cavity rises in the working process of the laser ranging device. However, as the first sealing cavity 52 and the second sealing cavity 42 achieve the effect of isolating the water vapor, and the water vapor at the higher temperature is unable to enter into the first sealing cavity 52 and the second sealing cavity 42, the temperature of the water vapor in the first sealing cavity 52 and the second sealing cavity 42 is lower. The temperature difference of the water vapor and the light-transmitting sheet 20 is smaller, so that it is difficult to form the condensation moisture. Second, the volume of the first sealing cavity 52 and of the second sealing cavity 42 is much smaller than that of the accommodating cavity, so that the amount of the water vapor in the first sealing cavity 52 and the second sealing cavity 42 is very small, that is, “a raw material” in the first sealing cavity 52 and the second sealing cavity 42 that can form the condensation moisture is less. Therefore, the condensation phenomenon of the water vapor on the inner side of the light-transmitting sheet 20 and on the incident side of the emission lens module 32 can be effectively reduced. Therefore, even when the laser ranging device is in an extreme environment at a lower temperature and a higher humidity, as the first sealing cavity 52 and the second sealing cavity 53 achieve the effect of isolating the water vapor, it is difficult for the water vapor to form the condensation moisture in the region of the light-transmitting sheet 20 corresponding to the receiving lens module 42 and the emission lens module 52, which effectively reduces the chances that the detecting echo beam and the detecting beam affected by the condensation moisture further affects the ranging performance of the laser ranging device. In an embodiment, on the basis of achieving anti-condensation by forming the first sealing cavity 52 and the second sealing cavity 53, it is also possible to collocate other anti-condensation methods in the laser ranging device, e.g., the light-transmitting sheet 20 is coated with a hydrophobic film layer; and/or, the light-transmitting sheet 20 is provided with a heating member thereon, e.g., a heating resistive wire, and/or, a moisture-absorbent member is provided in the first sealing cavity 52 and the second sealing cavity 53.

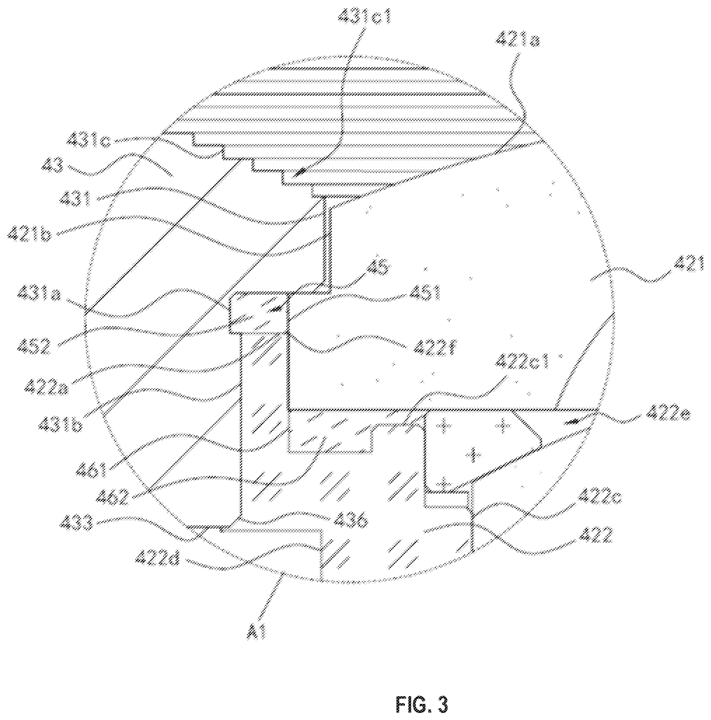

As shown in FIG. 2 and FIG. 3, in some embodiments, the first enclosing member 43 includes a first inner wall surface 431, a first end surface 432, and a second end surface 433. The first inner wall surface 431 is enclosed to form a first accommodating space 434. At least a portion of the first optical element 421 is exposed to the first accommodating space 434. The first end surface 432 is connected to an end of the first inner wall surface 431 closer to the light-transmitting sheet 20. The first end surface 432 has a first through-hole 435 communicating with the first accommodating space 434. A second end surface 433 is connected to an end of the first inner wall surface 431 farther away from the light-transmitting sheet 20 and has a second through hole 436 communicating with the first accommodating space 434. The first end surface 432 is hermetically connected to the light-transmitting sheet 20. The first inner wall surface 431 is hermetically connected to the portion of the first optical element 421 exposed to the first accommodating space 434 to form the first sealing cavity 52 between the light-transmitting sheet 20 and the first optical element 421. The first enclosing member 43 is configured to provide an assembly space for the first optical element 421 and protect the first optical element 421. The first enclosing member 43 is also configured to provide a light-transmitting passage to allow a light ray to be emitted into and out of the first optical element 421. Further, the first inner wall surface 431 is hermetically connected to the portion of the first optical element 421 exposed to the first accommodating space 434, which can prevent the water vapor from entering the first sealing cavity 52 from the connection place between the first inner wall surface 431 and the first optical element 421.

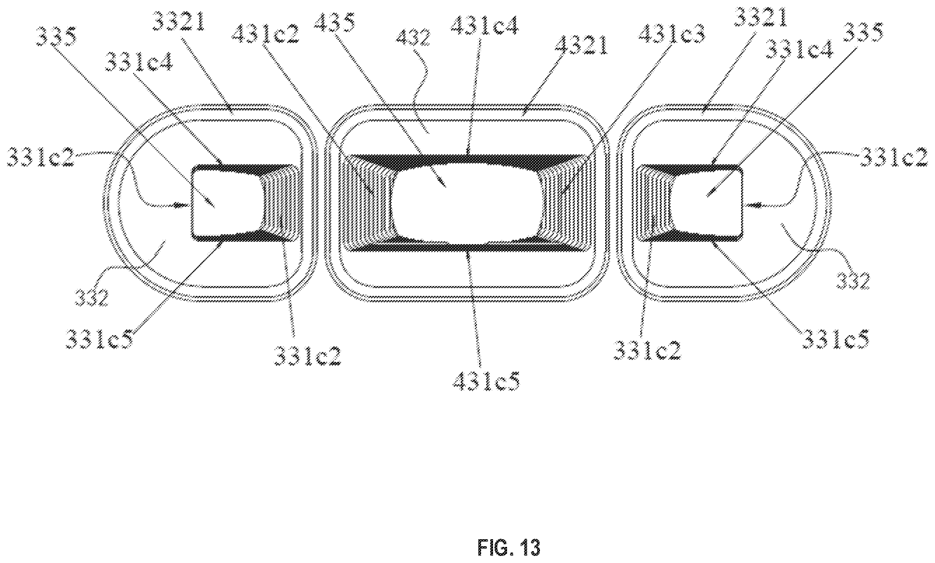

As shown in FIG. 13, in some embodiments, the first end surface 432 has a first sealing path 4321 thereon. The first sealing path 4321 is an annular path around the first through hole 435 for being hermetically connected to the light-transmitting sheet 20. The first sealing path 4321 is located in a planar portion of the first end surface 432. The planar portion of the first end surface 432 and the inner side of the light-transmitting sheet 20 are parallel to each other, thereby facilitating the sealing connection between the first sealing path 4321 and the light-transmitting sheet 20. The laser receiving module 40 can further include a first sealing connecting structure 44. The first sealing connecting structure 44 is configured to realize a sealing connection between the first sealing path 4321 and the light-transmitting sheet 20.

In an embodiment, the first sealing connecting structure 44 can include a first sealing member. The first sealing member is located between the first sealing path and the light-transmitting sheet 20, and pressed against the first sealing path and the inner side of the light-transmitting sheet 20 to realize the sealing connection between the first sealing path and the light-transmitting sheet 20. The first sealing member can be a sealing rubber ring, a rubber ring or the like.

In another embodiment, the first sealing connecting structure 44 includes a first sealing bulge 441, a first sealing groove 442, and a first sealing rubber ring 443. The first sealing bulge 441 can be arranged on the first end surface 432 and along the first sealing path. The first sealing groove 442 is arranged on a first light-transmitting surface of the light-transmitting sheet 20 closer to the laser receiving module 40, or the first sealing groove 442 is arranged on the first end surface 432 and along the first sealing path. The first sealing bulge 441 is provided on the first light-transmitting surface of the light-transmitting sheet 20 closer to the laser receiving module 40. The first sealing bulge 441 is embedded into the first sealing groove 442 and hermetically connected to the first sealing groove 442 via the first sealing rubber ring 443. Compared to the use of the first sealing member to directly realize the sealing connection between the first sealing path and the light-transmitting sheet 20, as the light-transmitting sheet 20 is generally made of a smooth material, such as glass, the inner side of the light-transmitting sheet 20 is relatively smooth. Therefore, the first sealing member is prone to move, thereby leading to a sealing failure. However, in an embodiment of this application, the first sealing bulge 441 and the first sealing groove 442 cooperate with each other to prevent the sealing failure due to the movement of the first sealing bulge 441. Further, the first sealing bulge 441 and the first sealing groove 442 cooperate with each other to realize the positioning and installation of the laser receiving module 40 in the accommodating cavity 51.

When the first sealing groove 442 is provided in the first end surface 432, the first sealing bulge 441 is connected to the inner side of the light-transmitting sheet 20. The first sealing bulge 441 can be integrally molded with the light-transmitting sheet 20. When the first sealing groove 442 is provided on the inner side of the light-transmitting sheet 20, the first sealing bulge 441 is connected to the first end surface 432. The first sealing bulge 441 can be integrally molded with the first enclosing member 43. The first sealing bulge 441 and the first enclosing member 43 can be made of a non-light-transmitting material, i.e., the first enclosing member 43 and the first sealing connecting structure 44 also have a certain light-blocking effect so that a stray light outside the first sealing cavity 52 does not enter the receiving lens module 42 due to the blocking of the first enclosing member 43 and the first sealing connecting structure 44, thereby reducing the chances that the stray light enters the receiving lens module 42 and affects the normal operation of the laser receiving module 40.

When the first sealing groove 442 is provided in the first end surface 432, the first sealing bulge 441 is connected to the inner side of the light-transmitting sheet 20. The first sealing bulge 441 can also be spliced with the light-transmitting sheet 20 after being molded with the light-transmitting sheet 20 separately. To ensure a sealing effect, a splicing structure between the first sealing bulge 441 and the light-transmitting sheet 20 can be a full-circle welding connection or a full-circle gluing connection. When the first sealing groove 442 is provided on the inner side of the light-transmitting sheet 20, the first sealing bulge 441 is connected to the first end surface 432. The first sealing bulge 441 can also be spliced with the first enclosing member 43 after being molded with the first enclosing member 43 separately. To ensure the sealing effect, the splicing structure between the first sealing bulge 441 and the first enclosing member 42 can be the full-ring welding connection or the full-ring gluing connection. The first sealing bulge 441 and the first enclosing member 43 can be made of a non-light-transmitting material, i.e., the first enclosing member 43 and the first sealing connecting structure 44 also have a certain light-blocking effect so that the stray light outside the first sealing cavity 52 does not enter the receiving lens module 42 due to the blocking of the first enclosing member 43 and the first sealing connecting structure 44, thereby reducing the chances that the stray light enters the receiving lens module 42 and affects the normal operation of the laser receiving module 40. In yet another embodiment of this application, the first sealing connecting structure 44 includes a first welding connecting structure. The first welding connecting structure is formed by welding the first end surface 432 and the light-transmitting sheet 20 along the first sealing path. A welding method can be ultrasonic welding, laser welding or the like.

Continuing to refer to FIG. 2 and FIG. 3, in some embodiments, the first inner wall surface 431 includes a first sealing part 431a. The first sealing part 431a is arranged around the portion of the first optical element 421 exposed to the first accommodating space 434 and hermetically connected to the portion of the first optical element 421 exposed to the first accommodating space 434. The first sealing part 431a is configured to be hermetically connected to the first enclosing member 43 and the first optical element 421 to realize the sealing connection between the first enclosing member 43 and the first optical element 421. The first sealing part 431a can be provided.

In an embodiment, the laser receiving module 40 also includes a second sealing connecting structure 45 for realizing a sealing connection between the first sealing part 431a and the portion of the first optical element 421 exposed to the first accommodating space 434.

The second sealing connecting structure 45 includes a second sealing groove 451 and a second sealing adhesive ring 452. The first optical element 421 includes a first incident surface 421a closer to the light-transmitting sheet 20 and a first sidewall 421b connected to the first incident surface 421a. The portion of the first optical element 421 exposed to the first accommodating space 434 includes the first incident surface 421a and the end of the first sidewall 421b closer to the light-transmitting sheet 20. The first sealing part 431a and the end of the first sidewall 421b closer to the light-transmitting sheet 20 are enclosed to form a second sealing groove 451. The second sealing rubber ring 452 is filled in the second sealing groove 451. It is to be understood that the second sealing rubber ring 452 is abutted against the first sealing part 431a and the end of the first sidewall 421b closer to the light-transmitting sheet 20. The sealing between the first sealing part 431a and the first optical element 421 can be enhanced by the second sealing rubber ring 452, so as to achieve a better sealing effect.

In an embodiment, the first sealing connecting structure 44 is configured to realize a sealing connection between the first sealing path 4321 and the light-transmitting sheet 20 so that the first enclosing member 43 and the light-transmitting sheet 20 are hermetically connected to each other. The second sealing connecting structure 45 is configured to realize a sealing connection between the first sealing part 431a and the first optical element 421 so that the first enclosing member 43 and the first optical element 421 are hermetically connected. Further, the first enclosing member 43 is enclosed between the light-transmitting sheet 20 and the first optical element 421 to form the first sealing cavity 52.

In some embodiments, the receiving lens module 42 also includes a first lens barrel 422. The first lens barrel 422 includes a first top wall 422a and a first bottom wall 422b arranged opposite to each other, and the first lens barrel 422 also includes a first inner wall 422c and a first outer wall 422d that are connected between the first top wall 422a and the first bottom wall 422b. The first inner wall 422c is located inside the first outer wall 422d for enclosing and forming a first assembly space 422e. The first assembly space 422e is configured to assemble the receiving optical element. The first top wall 422a is provided with a third through hole 422f communicating with the first assembly space 422e. The first bottom wall 422b is provided with a fourth through hole 422g communicating with the first assembly space 422e.

The first inner wall surface 431 also includes a first connecting part 431b. The first connecting part 431b is located at the side of the first sealing part 431a farther away from the light-transmitting sheet 20. The first lens barrel 422 enters the first accommodating space 434 via the second through hole 436. The side of the first outer wall 422d closer to the light-transmitting sheet 20 is connected to the first connecting part 431b. The side of the first optical element 421 closer to the light-transmitting sheet 20 goes beyond the first assembly space 422e via the third through hole 422f, is exposed to the first accommodating space 434 and is hermetically connected to the first sealing part 431a.

The side of the first outer wall 422d closer to the light-transmitting sheet 20 and the first connecting part 431b can be threadedly connected, that is, the first enclosing member 43 is threadedly connected to the first lens barrel 422. The side of the first outer wall 422d closer to the light-transmitting sheet 20 and the first connecting part 431b can be connected by laser welding, ultrasonic welding and so on. The first enclosing member 43 is usually referred to as a locking ring. The first optical element 421 arranged in the third through hole 422f is fixedly mounted on the first lens barrel 422 with the first enclosing member 43 not to be detached from the first lens barrel 422.

The first inner wall 422c includes a first bearing part 422c1 formed by extending proximately towards to an interior of first assembly space 422e. The first bearing part 422c1 is annular for bearing the first optical element 421. The first bearing part 422c1 has a third sealing groove 461 arranged in a full circle. The third sealing groove 461 is filled with a third sealing rubber ring 462 so that the first optical element 421 and the first inner wall 422c are hermetically connected to each other. The first bearing part 422c1 and the first enclosing member 43 are utilized to limit the upper and lower sides of the first optical element 421, so that the first optical element 421 is fixedly mounted on the first lens barrel 422 and does not fall out of the first lens barrel 422. The third sealing rubber ring 462 can realize the sealing between the first lens barrel 422 and the first optical element 421 to further insulate the water vapor, and to prevent the water vapor from entering the first sealing cavity 52 through a gap between the first optical element 421 and the first inner wall 422c.

As shown in FIG. 2 and FIG. 3, in an embodiment, the first inner wall surface 431 also includes a first light-blocking part 431c. The first light-blocking part 431c is connected to the end of the first sealing part 431a closer to the light-transmitting sheet 20. An angle range covered by a space formed by the enclosure of the first light-blocking part 431c matches the receiving angle of view β of the laser receiving module 40 (the receiving angle of view β includes a receiving angle of view βₓ in a horizontal direction and a receiving angle of view β_{y} in a vertical direction).

A first light-blocking groove 431c1 is provided on at least a portion of the wall surface of the first light-blocking part 431c. The first light-blocking groove 431c1 is configured to block a stray light emitted toward the first light-blocking part 431c. The first light-blocking groove 431c1 can prevent at least a portion of the light emitted to the first light-blocking part 431c from overlapping with the normal optical path of the laser receiving module 40 after reflection, which in turn can reduce the impact of the stray light on the normal operating performance of the laser receiving module 40.

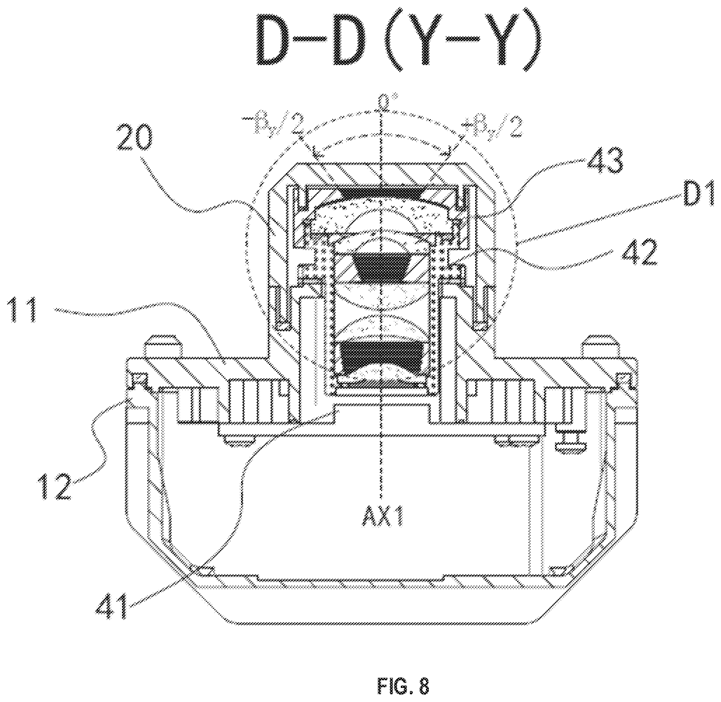

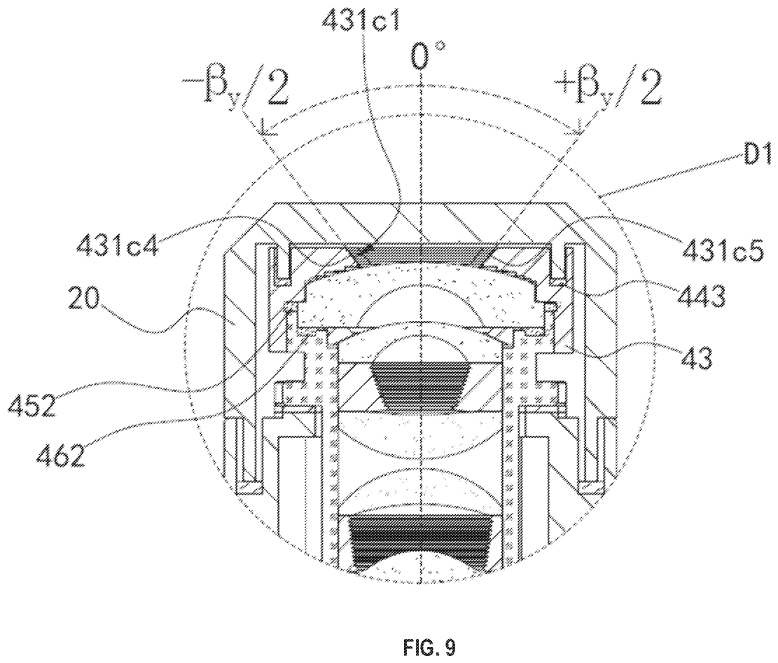

As shown in FIG. 2 and FIG. 8, the laser detector 41 is symmetrically arranged on both sides of a first optical axis AX1 (the receiving lens module 42 has the first optical axis AX1) in both a horizontal direction and a vertical direction. As shown in FIG. 2 and FIG. 9, the first light-blocking part 431c includes a first light-blocking wall surface 431c2, a second light-blocking wall surface 431c3, a third light-blocking wall surface 431c4, and a fourth light-blocking wall surface 431c5. The first light-blocking wall surface 431c2 and the second light-blocking wall surface 431c3 are symmetrically arranged on the two sides of the first optical axis AX1 in the horizontal direction. The third light-blocking wall surface 431c4 and the fourth light-blocking wall surface 431c5 are symmetrically arranged on the two sides of the first optical axis AX1 in the vertical direction. An angle range covered by a space defined by the first light-blocking wall surface 431c2 and the second light-blocking wall surface 431c3 matches the receiving angle of view βₓ of the laser receiving module 40 in the horizontal direction. The angle range covered by the space defined by the third light-blocking wall surface 431c4 and the fourth light-blocking wall surface 431c5 matches the receiving angle of view β_{y} of the laser receiving module 40 in the vertical direction.

As shown in FIG. 2, in the horizontal direction X-X, the space defined between the first light-blocking wall surface 431c2 and the second light-blocking wall surface 431c3 is configured to allow the receiving lens module 42 of the laser receiving module 40 to receive an echo laser beam within a range of the preset receiving optical path in the horizontal direction X-X. Specifically, the space defined between the first light-blocking part 431c and the second light-blocking wall surface 431c3 included in the first light-blocking part 431c corresponding to the laser receiving module 40 is configured to allow the receiving lens module 42 of the laser receiving module 40 to receive an echo laser beam at an angle in a range of −(βₓ/2) to +(βₓ/2) in the horizontal direction X-X. Specifically, as shown in FIG. 8 and FIG. 9, in the vertical direction X-X, the space defined between the third light-blocking wall surface 431c4 and the fourth light-blocking wall surface 431c5 is configured to allow the receiving lens module 42 of the laser receiving module 40 to receive an echo laser beam within a range of a preset receiving optical path in the vertical direction Y-Y. Specifically, the space defined between the third light-blocking part 431c4 and the second light-blocking wall surface 431c5 included in the first light-blocking part 431c corresponding to the laser receiving module 40 is configured to allow the receiving lens module 42 of the laser receiving module 40 to receive an echo laser beam at an angle in a range of −(β_{y}/2) to +(β_{y}/2) in the vertical direction Y-Y.

As shown in FIG. 2, FIG. 8, FIG. 9, and FIG. 13, the first light-blocking wall surface 431c2, the second light-blocking wall surface 431c3, the third light-blocking wall surface 431c4, and the fourth light-blocking wall surface 431c5 are all angularly arranged with the first optical axis AX1. An angle between the first light-blocking wall surface 431c2 and the first optical axis AX1 is −(βₓ/2) to 0. An angle between the second light-blocking wall surface 431c3 and the first optical axis AX1 is 0 to +(βₓ/2). An angle between the third light-blocking wall surface 431c4 and the first optical axis AX1 is −(β_{y}/2) to 0. An angle between the fourth light-blocking wall surface 431c5 and the first optical axis AX1 is 0 to +(β_{y}/2). The first light-blocking wall surface 431c2, the second light-blocking wall surface 431c3, the third light-blocking wall surface 431c4, and the fourth light-blocking wall surface 431c5 form the groove wall of the first light-blocking groove 431c1. A light ray emitted to the first light-blocking wall surface 431c2 and the second light-blocking wall surface 431c3 can be reflected a plurality of times within the first light-blocking groove 431c—between the first light-blocking wall surface 431c2 and the second light-blocking wall surface 431c3 after being reflected by the first light-blocking groove 431c—between the first light-blocking wall surface 431c2 and the second light-blocking wall surface 431c3. A light ray emitted to the third light-blocking wall surface 431c4 and the fourth light-blocking wall surface 431c5 can be reflected a plurality of times within the first light-blocking groove 431c—between the third light-blocking wall surface 431c4 and the fourth light-blocking wall surface 431c5 after being reflected by the first light-blocking groove 431c—between the third light-blocking wall surface 431c4 and the fourth light-blocking wall surface 431c5. Therefore, energy effectively decays to achieve the effect of approximate extinction, so that at least a portion of light rays emitted to the first light-blocking part 431c can be prevented from being overlapped with the normal optical path of the laser receiving module 40 after being reflected, thereby reducing the impact of the stray light on the normal operating performance of the laser receiving module 40. It can be understood that when the light ray is reflected by a plurality of times within the first light blocking groove 431c1, the more times the light ray is reflected, the more energy decays, and the better the extinction effect is.

Further, the first light-blocking wall surface 431c2, the second light-blocking wall surface 431c3, the third light-blocking wall surface 431c4, and the fourth light-blocking wall surface 431c5 are all successively provided with the plurality of first light-blocking grooves 431c1. The plurality of first light-blocking grooves 431c—are arranged in a whole circle along the first light-blocking wall surface 431c2, the second light-blocking wall surface 431c3, the third light-blocking wall surface 431c4, and the fourth light-blocking wall surface 431c5. Further, the first light-blocking groove 431c—is provided in a step shape.

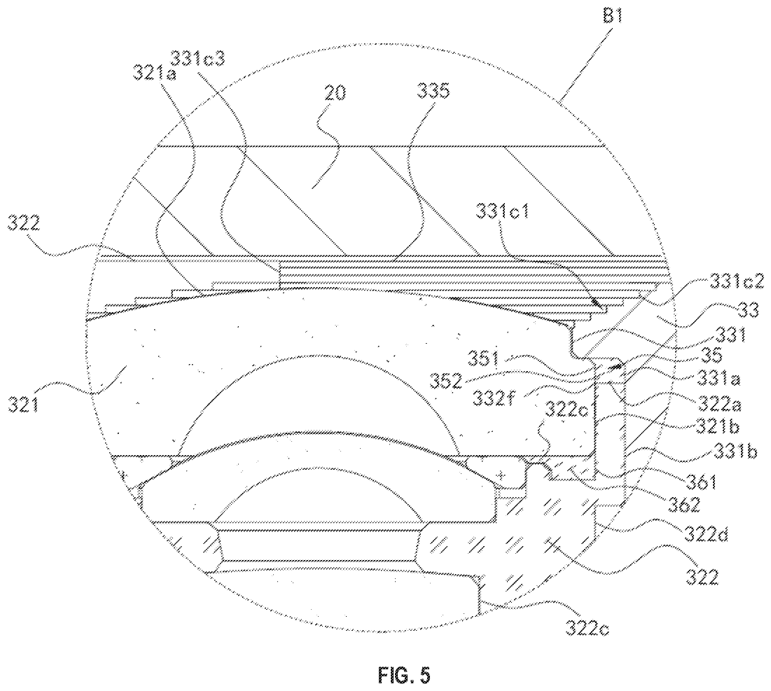

As shown in FIG. 1, FIG. 4, and FIG. 5, in some embodiments, the second enclosing member 33 includes a second inner wall surface 331, a third end surface 332, and a fourth end surface 333. The second inner wall surface 331 is enclosed to form a second accommodating space 334. At least a portion of the second optical element 321 is exposed to the second accommodating space 334. The third end surface 332 is connected to an end of the second inner wall surface 331 closer to the light-transmitting sheet 20 and has a fifth through-hole 335 communicating with the second accommodating space 334. A fourth end surface 333 is connected to an end of the second inner wall surface 331 farther away from the light-transmitting sheet 20. The fourth end surface 333 has a sixth through hole 336 communicating with the second accommodating space 334.

The third end surface 332 is hermetically connected to the light-transmitting sheet 20. The second inner wall surface 331 is hermetically connected to the portion of the second optical element 321 exposed to the second accommodating space 334 to form the second sealing cavity 53 between the light-transmitting sheet 20 and the second optical element 321. The second enclosing member 33 is configured to provide an assembly space for the second optical element 321 and protect the second optical element 321. The second enclosing member 33 is also configured to provide a light-transmitting passage to allow the light ray to be emitted into and out of the second optical element 321. Further, the second inner wall surface 331 is hermetically connected to the portion of the second optical element 321 exposed to the second accommodating space 334 so that the water vapor can be prevented from entering the second sealing cavity 53 from the connection place between the second inner wall surface 331 and the second optical element 321.

As shown in FIG. 13, in some embodiments, the third end surface 332 has a second sealing path 3321. The second sealing path 3321 is an annular path around the fifth through hole 335 for sealing connection with the light-transmitting sheet 20. The second sealing path 3321 is located at a planar portion of the third end surface 332. The planar portion of the third end surface 332 and the inner side of the light-transmitting sheet 20 are parallel to each other, thereby facilitating the sealing connection between the second sealing path 3321 and the light-transmitting sheet 20. The laser receiving module 40 also includes a third sealing connecting structure 34 for realizing a sealing connection between the second sealing path 3321 and the light-transmitting sheet 20.

In an embodiment, the third sealing connecting structure 34 can include the second sealing member. The second sealing member is located between the second sealing path 3321 and the light-transmitting sheet 20, and abutted against the second sealing path 3321 and the inner side of the light-transmitting sheet 20 to realize the sealing connection between the second sealing path 3321 and the light-transmitting sheet 20. The second sealing member can be a sealing rubber ring, a rubber ring or the like.

In another embodiment, the third sealing connecting structure 34 includes a fourth sealing bulge 341, a fourth sealing groove 342, and a fourth sealing rubber ring 343. The fourth sealing bulge 341 can be arranged on the first end surface 332 and along the first sealing path. The fourth sealing groove 342 is arranged on a first light-transmitting surface of the light-transmitting sheet 20 closer to the laser emission module 30, or the fourth sealing groove 342 is arranged on the third end surface 332 and along the second sealing path. The fourth sealing bulge 341 is provided on the first light-transmitting surface of the light-transmitting sheet 20 closer to the laser emission module 30. The fourth sealing bulge 341 is embedded into the fourth sealing groove 342 and hermetically connected to the fourth sealing groove 342 via the fourth sealing rubber ring 343. Compared to the use of the second sealing member to directly realize the sealing connection between the second sealing path and the light-transmitting sheet 20, as the light-transmitting sheet 20 is generally made of the smooth material, such as glass, the inner side of the light-transmitting sheet 20 is relatively smooth. Therefore, the second sealing member is prone to move, thereby leading to a sealing failure. In an embodiment, the fourth sealing bulge 341 and the fourth sealing groove 342 cooperate with each other to prevent the sealing failure due to the movement of the fourth sealing bulge 341. Further, the fourth sealing bulge 341 and the fourth sealing groove 342 cooperate with each other to realize the positioning and installation of the laser emission module 30 in the accommodating cavity 51.

When the fourth sealing groove 342 is provided in the third end surface 332. The fourth sealing bulge 341 is connected to the inner side of the light-transmitting sheet 20. The fourth sealing bulge 341 can be integrally molded with the light-transmitting sheet 20. When the fourth sealing groove 342 is provided on the inner side of the light-transmitting sheet 20, the fourth sealing bulge 341 is connected to the third end surface 332. The fourth sealing bulge 341 can be integrally molded with the second enclosing member 33. The fourth sealing bulge 341 and the second enclosing member 33 can be made of a non-light-transmitting material, that is, the second enclosing member 33 and the third sealing connecting structure 34 also have a certain light-blocking effect so that a stray light outside the second sealing cavity 42 does not enter the emission lens module 32 due to the blocking of the second enclosing member 33 and the third sealing connecting structure 34, thereby reducing the chances that the stray light enters the emission lens module 32 and affect the normal operation of the laser emission module 30.

When the fourth sealing groove 342 is provided in the third end surface 332, the fourth sealing bulge 341 is connected to the inner side of the light-transmitting sheet 20. The fourth sealing bulge 341 can also be spliced with the light-transmitting sheet 20 after being molded with the light-transmitting sheet 20 separately. To ensure a sealing effect, a splicing structure between the fourth sealing bulge 341 and the light-transmitting sheet 20 can be a full-circle welding connection or a full-circle gluing connection. When the fourth sealing groove 342 is provided on the inner side of the light-transmitting sheet 20, the fourth sealing bulge 341 is connected to the third end surface 332. The fourth sealing bulge 341 can also be spliced with the second enclosing member 33 after being molded with the second enclosing member 33 separately. To ensure the sealing effect, preferably, the splicing structure between the fourth sealing bulge 341 and the second enclosing member 32 can be the full-ring welding connection or the full-ring gluing connection. Therefore, the fourth sealing bulge 341 and the second enclosing member 33 can be made of a non-light-transmitting material, the second enclosing member 33 and the third sealing connecting structure 34 also have a certain light-blocking effect so that the stray light outside the second sealing cavity 42 does not enter the emission lens module 32 due to the blocking of the second enclosing member 33 and the third sealing connecting structure 34, thereby reducing the chances that the stray light enters the remission lens module 32 and affects the normal operation of the laser emission module 30.

In an embodiment, the third sealing connecting structure 34 includes a third welding connecting structure. The third welding connecting structure is formed by welding the third end surface 332 and the light-transmitting sheet 20 along the second sealing path 3321. A welding method can be ultrasonic welding, laser welding or the like.

Continuing to refer to FIG. 4 and FIG. 5, in some embodiments, the second inner wall surface 331 includes a second sealing part 331a. The second sealing part 331a is arranged around the portion of the second optical element 321 exposed to the second accommodating space 334 and hermetically connected to the portion of the second optical element 321 exposed to the second accommodating space 334. The second sealing part 331a is configured to be hermetically connected to the second enclosing member 33 and the second optical element 321 to realize the sealing connection between the first enclosing member 33 and the second optical element 321.

In an embodiment, the laser emission module 30 also includes a fourth sealing connecting structure 35. The fourth sealing connecting structure 35 is configured to realize a sealing connection between the second sealing part 331a and the portion of the second optical element 321 exposed to the second accommodating space 334.

The fourth sealing connecting structure 35 includes a fifth sealing groove 351 and a fifth sealing rubber ring 352. The second optical element 321 includes a second incident surface 321a closer to the light-transmitting sheet 20 and a second sidewall 321b connected to the second incident surface 321a. The portion of the second optical element 321 exposed to the second accommodating space 334 includes the second incident surface 321a and the end of the second sidewall 321b closer to the light-transmitting sheet 20. The second sealing part 331a and the end of the second sidewall 321b closer to the light-transmitting sheet 20 are enclosed to form a fifth sealing groove 351. The fifth sealing rubber ring 352 is filled in the fifth sealing groove 351. It is to be understood that the fifth sealing rubber ring 352 is abutted against the second sealing part 331a and the end of the second sidewall 321b closer to the light-transmitting sheet 20. The sealing between the second sealing part 331a and the second optical element 321 can be enhanced by the fifth sealing rubber ring 352, so as to achieve a better sealing effect.

In an embodiment, the third sealing connecting structure 34 is configured to realize a sealing connection between the second sealing path 3321 and the light-transmitting sheet 20 so that the second enclosing member 33 and the light-transmitting sheet 20 are hermetically connected to each other. The fourth sealing connecting structure 35 is configured to realize a sealing connection between the second sealing part 331a and the second optical element 321 so that the second enclosing member 33 and the second optical element 321 are hermetically connected. Further, the second enclosing member 33 is enclosed between the light-transmitting sheet 20 and the second optical element 321 to form the second sealing cavity 53.

In some embodiments, the emission lens module 32 also includes a second lens barrel 322. The second lens barrel 322 includes a first top wall 322a and a first bottom wall 322b arranged opposite to each other, and the second lens barrel 322 also includes a second inner wall 322c and a second outer wall 322d that are connected between the second top wall 322a and the second bottom wall 322b. The second inner wall 322c is located inside the second outer wall 322d for enclosing and forming a second assembly space 322e. The second assembly space 322e is configured to assemble the emission optical element. The second top wall 322a is provided with a seventh through hole 322f communicating with the second assembly space 322e. The second bottom wall 322b is provided with an eighth through hole 322g communicating with the first assembly space 422e.

The second inner wall surface 331 also includes a second connecting part 331b. The second connecting part 331b is located at the side of the second sealing part 331a farther away from the light-transmitting sheet 20. The second lens barrel 322 enters the second accommodating space 334 via the sixth through hole 336. The side of the second outer wall 322d closer to the light-transmitting sheet 20 is connected to the second connecting part 331b. The side of the second optical element 321 closer to the light-transmitting sheet 20 goes beyond the second assembly space 322e via the seventh through hole 322f, is exposed inside the second accommodating space 334 and is hermetically connected to the first sealing part 331a.

The side of the second outer wall 322d closer to the light-transmitting sheet 20 and the first connecting part 331b can be threadedly connected, that is, the second enclosing member 33 is threadedly connected to the second lens barrel 322. Of course, the side of the second outer wall 322d closer to the light-transmitting sheet 20 and the second connecting part 331b can be connected by laser welding, ultrasonic welding and so on. The first enclosing member 33 is usually referred to as a locking ring. The second optical element 321 arranged in the third through hole 422f is fixedly mounted on the second lens barrel 322 with the second enclosing member 33 not to be detached from the second lens barrel 322.

The second inner wall 322c includes a second bearing part 322c1 formed by extending proximately towards to the interior of second assembly space 322e. The second bearing part 322c1 is annular for bearing the second optical element 321. The second bearing part 322c1 has a sixth sealing groove 361 arranged in a full circle. The sixth sealing groove 361 is filled with a sixth sealing rubber ring 362 so that the second optical element 321 and the second inner wall 322c are hermetically connected to each other. The second bearing part 322c1 and the second enclosing member 33 are utilized to limit the upper and lower sides of the second optical element 321, so that the second optical element 321 is fixedly mounted on the second lens barrel 322 and does not fall out of the second lens barrel 322. The sixth sealing rubber ring 362 can realize the sealing between the second lens barrel 322 and the second optical element 321 to prevent the water vapor from entering the second sealing cavity 53 through a gap between the second optical element 321 and the second inner wall 322c.

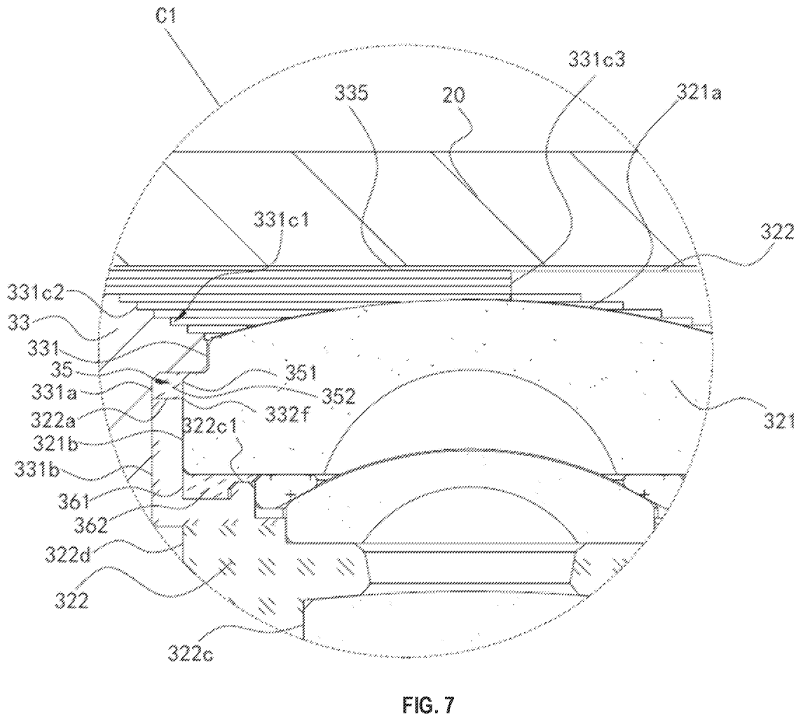

As shown in FIG. 4 and FIG. 7, in an embodiment, the second inner wall surface 331 also includes a second light-blocking part 331c. The second light-blocking part 331c is connected to the end of the second sealing part 331a closer to the light-transmitting sheet 20. An angle range covered by a space formed by the enclosure of the second light-blocking part 331c matches the receiving angle of view α of the laser emission module 30 (the emission angle of view α includes a receiving angle of view αₓ in a horizontal direction and a receiving angle of view α_{y} in a vertical direction). The second light-blocking part 331c can adjust the emission angle of view α of the laser emission module 30 so that the emission field angle α of the laser emission module 30 is a preset angle of view.

A second light-blocking groove 331c—is provided on at least a portion of the wall surface of the second light-blocking part 331c. The second light-blocking groove 331c—is configured to block a stray light emitted toward the second light-blocking part 331c. The second light-blocking groove 331c—can prevent at least a portion of the light emitted to the second light-blocking part 331c from being overlapped with the normal optical path of the laser emission module 30 after reflection, which in turn can reduce the impact of the stray light on the normal operating performance of the laser emission module 30.

As shown in FIG. 1, in an embodiment, the laser ranging device includes two laser emission modules 30 and one laser receiving module 40. The two laser emission modules 30 are located on either side of the laser receiving module 40. in the horizontal direction X-X, a second optical axis AX2 (the emission lens module 32 has the second optical axis AX2) of the emission lens module 32 corresponding to the laser 31 included in the two laser emission modules 30 is farther away from the side of the laser receiving module 40. After receiving the laser beam emitted by the respective corresponding laser 31, the laser beam L is guided by the emission lens module 32 of the two laser emission modules 30 to the side of the second optical axis AX2 closer to the laser receiving module 40 so that the laser beam emitted by the emission lens module 32 of the two laser emission modules 30 has an overlapping area in the middle, thereby reducing the detection blind region of the laser ranging device. When the laser ranging device performs close-distance detection, even if there is pixel offset, the center view of the laser ranging device still is irradiated by the laser beam so that the phenomenon of a missing point cloud in the center view of the laser ranging device is avoided.

A combination of the emission angle of view covered by the laser beam L emitted by the emission lens modules 32 of the two laser emission modules 30 matches with the receiving angle of view covered by the echo laser beam R received by the receiving lens module 42 of the laser receiving module 40, so that the laser receiving module 40 can receive the echo laser beam R formed after the laser beam L emitted by the two laser emission modules 30 towards a detection region is reflected by an obstacle in the detection region. The emission angle of view is sliced with the two laser emission modules 30 by the laser ranging device provided in this application, which facilitates not only expanding the detection view of the laser ranging device, but also facilitates reducing the size of each of the lasers 31 and facilitates reducing the cost of the lasers 31 used.

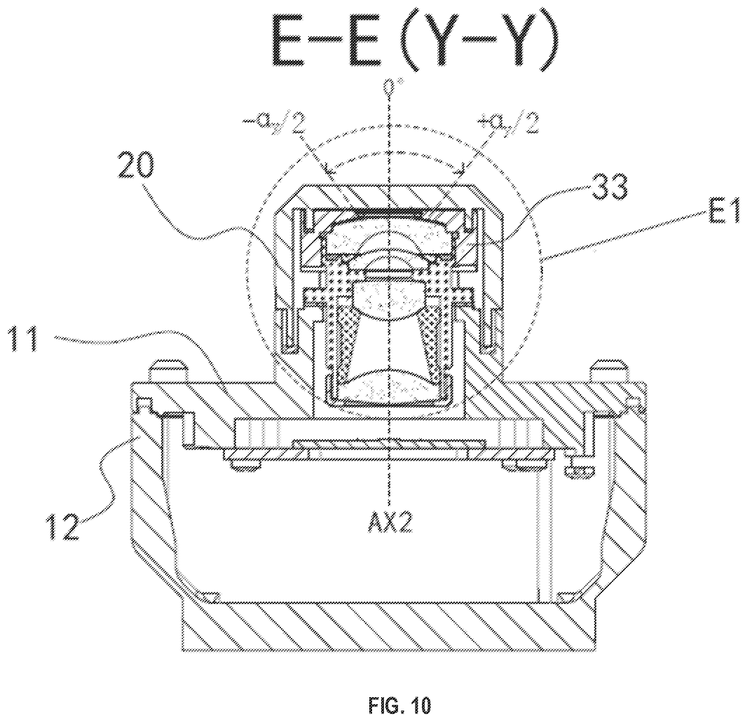

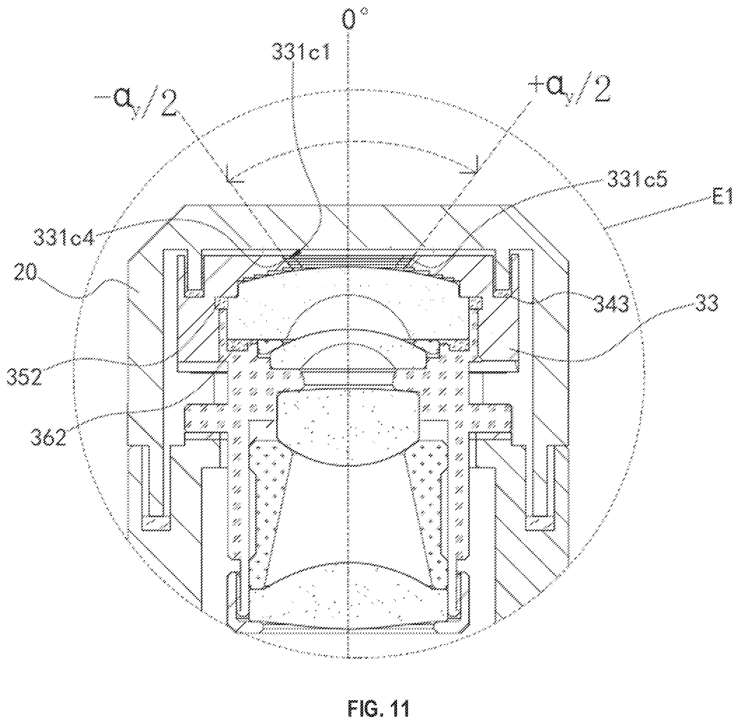

As shown in FIG. 4, in the horizontal direction X-X, a horizontal emission angle of view covered by the laser beam emitted by the emission lens module 32 of the laser emission module 30 located on the left is 0 to +αₓ. As shown in FIG. 6, a horizontal emission angle of view covered by the laser beam emitted by the emission lens module 32 of the laser emission module 30 located on the right is −αₓ to 0. The combined horizontal emission angle of view covered by the laser beam emitted by the two laser emission modules 30 is −αₓ to +αₓ. As shown in FIG. 2, a horizontal receiving angle of view covered by the laser beam received by the laser receiving module 40 is −(βₓ/2) to +(βₓ/2), where βₓ=2*αₓ. As shown in FIG. 10 and FIG. 11, in the vertical direction Y-Y, a vertical emission angle of view covered by the laser beam L emitted by the emission lens module 32 of the laser emission module 30 located on the left and a vertical emission angle of view covered by the laser beam L emitted by the emission lens module 32 of the laser emission module 30 located on the right are both −(α_{y}/2) to +(α_{y}/2). As shown in FIG. 8 and FIG. 9, a vertical receiving angle of view covered by the echo laser beam R received by the laser receiving module 40 is −(β_{y}/2) to +(β_{y}/2), where β_{y}=α_{y}.

As shown in FIG. 4 and FIG. 6, the second light-blocking parts 331c corresponding to the two laser emission modules 30 are symmetrically arranged in the horizontal direction. In the horizontal direction X-X, the second light-blocking parts 331c corresponding to each of the laser emission modules 30 include a fifth light-blocking wall surface 331c2 and a sixth light-blocking wall surface 331c3 oppositely arranged. The fifth light-blocking wall surface 331c2 is closer to the first optical axis AX1 compared to the sixth light-blocking wall surface 331c3. A space defined between the fifth light-blocking wall surface 331c2 and the sixth light-blocking wall surface 331c3 is configured to allow light ray emitted by the emission lens module 32 of the laser emission module 30 to be emitted out in the horizontal direction X-X in the preset emission optical path range. A space defined between the fifth light-blocking wall surface 331c2 and the sixth light-blocking wall surface 331c3 included in the second light-blocking part 331c corresponding to the laser emission module 30 located on the left side is configured to allow a light ray emitted by the emission lens module 32 of the laser emission module 30 located on the left side to be emitted in the horizontal direction X-X within an emission angle range of 0 to +αₓ. A space defined between the fifth light-blocking wall surface 331c2 and the sixth light-blocking wall surface 331c3 included in the second light-blocking part 331c corresponding to the laser emission module 30 located on the right side is configured to allow a light ray emitted by the emission lens module 32 of the laser emission module 30 located on the right side to be emitted in the horizontal direction X-X within an emission angle range of −αₓ to 0.

As shown in FIG. 11, in the vertical direction Y-Y, the second light-blocking part 331c corresponding to each of the laser emitting modules 30 includes a seventh light-blocking wall surface 331c4 and an eighth light-blocking wall surface 331c5 symmetrically arranged. A space defined between the seventh light-blocking wall surface 331c4 and the eighth light-blocking wall surface 331c5 is configured to allow a light ray emitted by the emission lens module 32 of the laser emission module 30 to be emitted out in the vertical direction Y-Y within a preset emission optical path. A space defined between the seventh light-blocking wall surface 331c4 and the eighth light-blocking wall surface 331c5 included in the second light-blocking part 331c corresponding to the laser emission module 30 located on the left side is configured to allow a light ray emitted by the emission lens module 32 of the laser emission module 30 located on the left side to be emitted in the vertical direction Y-Y within an emission angle range of −(α_{y}/2) to +(α_{y}/2). A space defined between the seventh light-blocking wall surface 331c4 and the eighth light-blocking wall surface 331c5 included in the second light-blocking part 331c corresponding to the laser emission module 30 located on the right side is configured to allow a light ray emitted by the emission lens module 32 of the laser emission module 30 located on the right side to be emitted in the vertical direction Y-Y in an emission angle range of −(α_{y}/2) to +(αₓ/2).

As shown in FIG. 4, FIG. 5, FIG. 6, FIG. 7, and FIG. 13, the fifth light-blocking wall surface 331c2 and the second optical axis AX2 are angularly arranged. The sixth light-blocking wall surface 331c3 is arranged parallel to the second optical axis AX2. An angle between the fifth light-blocking wall surface 331c2 corresponding to the emission lens module 32 included in the laser emission module 30 located on the left side and the second optical axis AX2 is 0 to +αₓ. An angle between the fifth light-blocking wall surface 331c2 corresponding to the emission lens module 32 included in the laser emission module 30 located on the right side and the second optical axis AX2 is −αₓ to 0. As shown in FIG. 10 and FIG. 11, the seventh light-blocking wall surface 331c4 and the eighth light-blocking wall surface 331c5 and the second optical axis AX2 are angularly arranged. An angle between the seventh light-blocking wall surface 331c4 and the second optical axis AX2 is 0 to +(α_{y}/2). An angle between the eighth light-blocking wall surface 331c5 and the second optical axis AX2 is −(α_{y}/2) to 0.

In some embodiments, multiple second light blocking grooves 331c—are sequentially arranged along a wall surface extension direction of the fifth light blocking wall surface 331c2, the seventh light blocking wall surface 331c4, and the eighth light blocking wall surface 331c5.

The fifth light-blocking wall surface 331c2 and the sixth light-blocking wall surface 331c3 constitute the groove wall of the second light-blocking groove 331c1. A light ray emitted on the fifth light-blocking wall surface 331c2 and the sixth light-blocking wall surface 331c3 can be reflected a plurality of times in the second light-blocking groove 331c—after being reflected by the second light-blocking groove 331c—of the fifth light-blocking wall surface 331c2 and the sixth light-blocking wall surface 331c3. Energy effectively decays, which achieves a near-extinction effect, thereby reducing the impact of the stray light on the normal working performance of the laser emission module 30. A light ray emitted in the second light-blocking groove 331c—is reflected a plurality of times in the second light-blocking groove 331c1. Energy effectively decays, which achieves a near-extinction effect, thereby preventing at least a portion of the light ray emitted to the second light-blocking part 331c from overlapping with the normal optical path of the laser emission module 30 after reflection, thereby further reducing the impact of the stray light on the normal working performance of the laser emission module 30. It can be understood that when the light ray is reflected by a plurality of times within the second light blocking groove 331c1, the more times the light ray is reflected, the more energy decays, and the better the extinction effect is.

The fifth light-blocking wall surface 331c2, the sixth light-blocking wall surface 331c3, and the seventh light-blocking wall surface 331c4 are sequentially provided with a plurality of second light-blocking grooves 331c1. Further, the second light-blocking groove 331c—is provided in a step shape.

As shown in FIG. 1 and FIG. 4, in some embodiments, the light-transmitting sheet 20 has a first engaging edge 21. The housing 10 has a second engaging edge 113. After the first engaging edge 21 and the second engaging edge 113 are hermetically connected, the light-transmitting sheet 20 and the housing 10 form the accommodating cavity 51.

The first engaging edge 21 is formed with a first connecting bulge 72. The second engaging edge 113 is formed with a first connecting groove 71. The first connecting bulge 72 is embedded into the first connecting groove 71 and hermetically connected to the first connecting groove 71 via a seventh sealing rubber ring 61 filled in the first connecting groove 71, or the first engaging edge 21 is formed with the first connecting groove 71. The second engaging edge 113 is formed with the first connecting bulge 72. The first connecting bulge 72 is embedded into the first connecting groove 71 and hermetically connected to the first connecting groove 71 via the seventh sealing rubber ring 61 filled in the first connecting groove 71. It should be understood that the light-transmitting sheet 20 and the housing 10 adopt a split design, which facilitates loading, unloading and replacement of the light-transmitting sheet 20, thereby prolonging the service life of the laser ranging device. In addition, through the coordinated connection of the first connecting bulge 72, the first connecting groove 71, and the seventh sealing rubber ring 61, the sealing at the connection place of the light-transmitting sheet 20 and the housing 10 can be ensured to prevent the external vapor from entering the accommodating cavity 51 through the connection place of the light-transmitting sheet 20 and the housing 10.

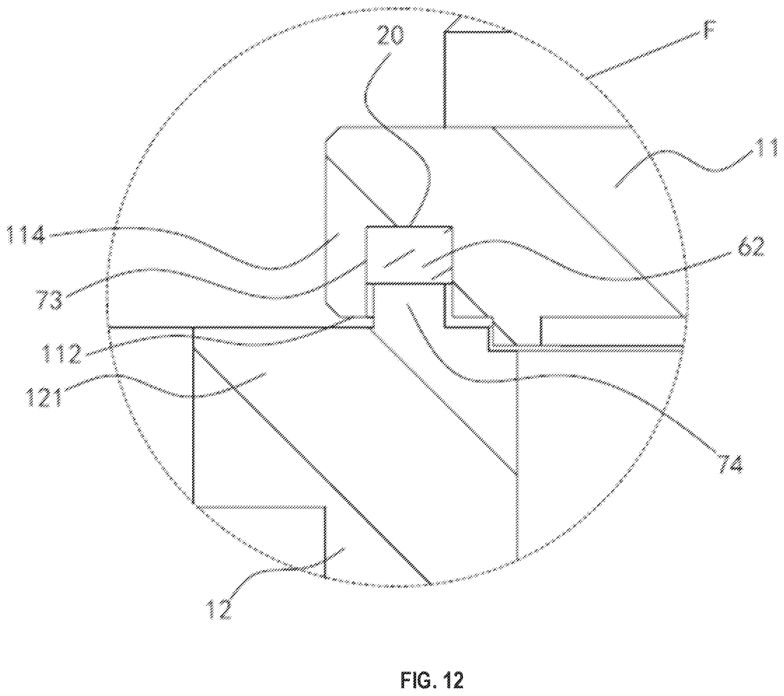

As shown in FIG. 1, FIG. 4, and FIG. 12, the housing 10 includes a first housing 11 and a second housing 12 connected to the first housing 11. The first housing 11 includes a first plate surface 111 facing the light-transmitting sheet 20. The second engaging edge 113 is provided on the first plate surface 111. The first housing 11 further includes a second plate surface 112. The second plate surface 112 has a third engaging edge 114 thereon. The second housing 12 has a fourth engaging edge 121 thereon. The third engaging edge 114 and the fourth engaging edge 121, when hermetically connected, collectively define an internal accommodating space of the housing 10.

The third engaging edge 114 is formed with a second connecting groove 73 thereon. The fourth engaging edge 121 is formed with a second connecting bulge 74 thereon. The second connecting bulge 74 is embedded into the second connecting groove 73 and hermetically connected to the second connecting groove 73 via an eighth sealing rubber ring 62 filled within the first connecting groove 71, or the third engaging edge 114 is formed with the second connecting groove 73 thereon. The fourth engaging edge 121 is formed with the second connecting bulge 74 thereon. The second connecting bulge 74 is embedded into the second connecting groove 73 and hermetically connected to the second connecting groove 73 via the eighth sealing rubber ring 62 filled within the second connecting groove 73.

The first housing 11 and the second housing 12 are detachably connected to facilitate the disassembly, assembly and maintenance of components in the accommodating cavity 51. The first housing 11 and the second housing 12 are cooperatively connected by the second connecting bulge 74, the second connecting groove 73, and the eighth sealing rubber ring 62, which ensures the sealing of the connection place of the first housing 11 and the second housing 12 and prevents an external water vapor from entering the accommodating cavity 51 through the connection place of the first housing 11 and the second housing 12.

As shown in FIG. 2 and FIG. 4, in an embodiment, the first housing 11 is further provided with a first mounting hole 115. The first mounting hole 115 passes through the first plate surface 111 and the second plate surface 112 for mounting the receiving lens module 42. The first housing 11 is further provided with a second mounting hole 116 thereon. The second mounting hole 116 passes through the first plate surface 111 and the second plate surface 112 for mounting the emission lens module 32, so that the first housing 11 can be utilized for providing support and limitation for the receiving lens module 42 and the emission lens module 32.

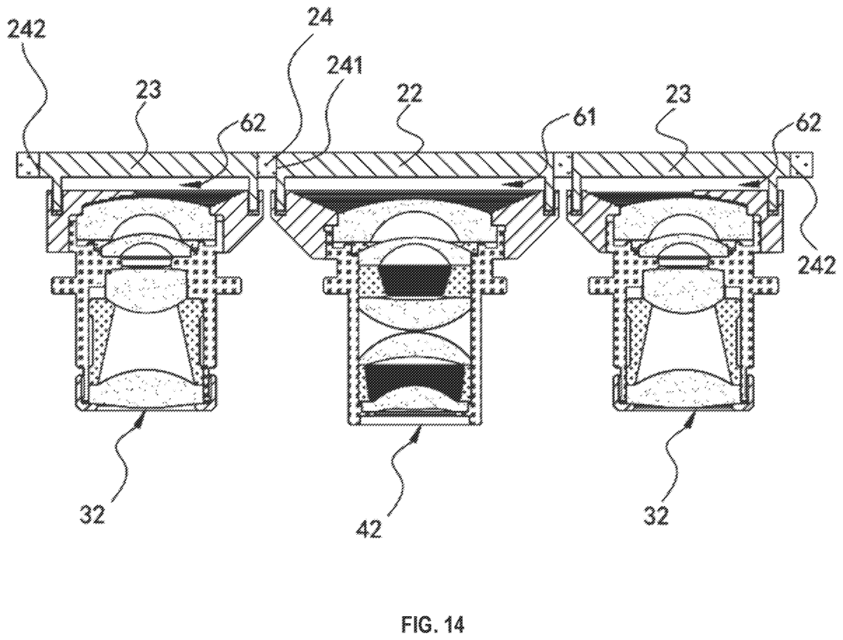

As shown in FIG. 14, in some embodiments, the light-transmitting sheet 20 includes a first light-transmitting sheet 22 and a second light-transmitting sheet 23. The receiving lens module 42 is provided between the laser detector 41 and the first light-transmitting sheet 22. The emission lens module 32 is provided between the laser 31 and the second light-transmitting sheet 23.

The first enclosing member 43 is provided between the first optical element 421 and the first light-transmitting sheet 22. The first enclosing member 43 has one end hermetically connected to the first light-transmitting sheet 22, and has the other end hermetically connected to the first optical element 421 to enclose between the first light-transmitting sheet 22 and the first optical element 421 to form the first sealing cavity 52. The second enclosing member 33 is provided between the second optical element 321 and the second light-transmitting sheet 23, and the second enclosing member 33 has one end hermetically connected to the second light-transmitting sheet 23, and has the other end hermetically connected to the second optical element 321 to enclose and form the second sealing cavity 53 between the second light-transmitting sheet 23 and the second optical element 321.

The first light-transmitting sheet 22 and the second light-transmitting sheet 23 are independent from each other and correspond to the receiving lens module 42 and the laser emission module 30 respectively, so that the number of the light-transmitting sheet 20 can be reduced and a production cost can be reduced.

The light-transmitting sheet 20 includes a third housing 24. The first engaging edge 21 is located on the third housing 24. The third housing 24 is provided with a first accommodation hole 241 and a second accommodation hole 242 thereon. The first accommodation hole 241 and the second accommodation hole 242 are spaced apart. The first accommodation hole 241 is configured to mount the first light-transmitting sheet 22. The second accommodation hole 242 is configured to mount the second light-transmitting sheet 23.

In some embodiments, as shown in FIG. 1, the laser ranging device includes two laser emission modules 30 and one laser receiving module 40. The two laser emission modules 30 are located on the two sides of the laser receiving module 40. A combined emission angle of view α of the two laser emission modules 30 matches with a receiving angle of view ß of the laser receiving module 40. The arrangement of the two laser emission modules 30 can be more flexible, which in turn realizes the miniaturized design of the laser ranging device. The two laser emission modules 30 are arranged, which also enhances the view receiving rate of the laser receiving module 40 and expands the detection angle of view of the laser ranging device. Further, the emission angle of view between the two laser emission modules 30 is roughly distributed on the two sides of the laser receiving module 40, which is convenient for the reception by the laser receiving module 40. It is also convenient to adjust the at least one of the laser emission modules 30 so that the emission angle of view α of the two laser emission modules 30 has an overlapping region in the middle. Therefore, the emission angle of view α covers the entire receiving angle of view β of the laser receiving module 40, thereby avoiding a detection blind spot.

The two laser emission modules 30 can be the same or different. When the two laser emission modules 30 are the same, in comparison with two different laser emission modules 30, because the two laser emission modules 30 have the same parameter, operations such as assembling and positioning are more convenient to perform. When the two laser emission modules 30 are different, various combinations of the two laser emission modules 30 may be implemented, which can satisfy more use scenarios.

What is claimed is:

1. A laser ranging device, comprising a housing, a light-transmitting sheet, at least one laser emission module, and at least one laser receiving module, wherein:
the light-transmitting sheet is connected to the housing to form an accommodating cavity; the laser emission module is located in the accommodating cavity and comprises a laser and an emission lens module; the emission lens module is arranged between the laser and the light-transmitting sheet and comprises at least one emission optical element; the laser receiving module is arranged within the accommodating cavity and comprises a laser detector and a receiving lens module; and the receiving lens module is arranged between the laser detector and the light-transmitting sheet and comprises at least one receiving optical element; and
the laser receiving module also comprises a first enclosing member; the first enclosing member is arranged between a first optical element and the light-transmitting sheet, has one end hermetically connected to the light-transmitting sheet, and has the other end hermetically connected to the first optical element to enclose and form a first sealing cavity between the light-transmitting sheet and the first optical element; and the first optical element is the receiving optical element closest to the light-transmitting sheet; and/or
the laser emission module also comprises a second enclosing member; the second enclosing member is arranged between a second optical element and the light-transmitting sheet, has one end hermetically connected to the light-transmitting sheet, and has the other end hermetically connected to the second optical element to enclose and form a second sealing cavity between the light-transmitting sheet and the second optical element; and the second optical element is an emission optical element closest to the light-transmitting sheet.

2. The laser ranging device according to claim 1, wherein:
the laser receiving module comprises the first enclosing member; the first enclosing member comprises a first inner wall surface, a first end surface, and a second end surface; the first inner wall surface encloses and forms a first accommodating space, at least a portion of the first optical element is exposed to the first accommodating space; the first end surface is connected to an end of the first inner wall surface closer to the light-transmitting sheet and has a first through hole communicating with the first accommodating space; and the second end surface is connected to an end of the first inner wall surface farther away from the light-transmitting sheet and has a second through hole communicating with the first accommodating space; and
the first end surface is hermetically connected to the light-transmitting sheet, and the first inner wall surface is hermetically connected to the portion of the first optical element exposed to the first accommodating space to form the first sealing cavity between the light-transmitting sheet and the first optical element.

3. The laser ranging device according to claim 2, wherein:
the first end surface has a first sealing path thereon, and the first sealing path surrounds the first through hole and is hermetically connected to the light-transmitting sheet; and/or
the first inner wall surface comprises a first sealing part, and the first sealing part is arranged around the portion of the first optical element exposed to the first accommodating space and is hermetically connected to the portion of the first optical element exposed to the first accommodating space.

4. The laser ranging device according to claim 3, wherein:
the first end surface has the first sealing path thereon, and the laser receiving module also comprises a first sealing connecting structure so that the first sealing path and the light-transmitting sheet are hermetically connected to each other; and
the first sealing connecting structure comprises a first sealing bulge, a first sealing groove, and a first sealing rubber ring; the first sealing bulge is arranged on the first end surface and along the first sealing path, and the first sealing groove is arranged on a first light-transmitting surface of the light-transmitting sheet closer to the laser receiving module, or the first sealing groove is arranged on the first end surface and along the first sealing path, the first sealing bulge is provided on the first light-transmitting surface of the light-transmitting sheet closer to the laser receiving module; and the first sealing bulge is embedded into the first sealing groove and hermetically connected to the first sealing groove via the first sealing rubber ring; or
the first sealing connecting structure comprises a first welding connecting structure, and the first welding connecting structure is formed after the first end surface and the light-transmitting sheet are welded along the first sealing path.

5. The laser ranging device according to claim 3, wherein:
the first inner wall surface comprises the first sealing part, and the laser receiving module also comprises a second sealing connecting structure so that the first sealing part and the portion of the first optical element exposed to the first accommodating space are hermetically connected to each other; and
the second sealing connecting structure comprises a second sealing groove and a second sealing rubber ring; the first optical element comprises a first incident surface closer to the light-transmitting sheet and a first sidewall connected to the first incident surface; the portion of the first optical element exposed to the first accommodating space comprises the first incident surface and an end of the first sidewall closer to the light-transmitting sheet; and the first sealing part and the end of the first sidewall closer to the light-transmitting sheet are enclosed to form the second sealing groove; and the second sealing ring fills in the second sealing groove.

6. The laser ranging device according to claim 3, wherein:
the receiving lens module also comprises a first lens barrel; the first lens barrel comprises a first top wall and a first bottom wall arranged opposite to each other, and also comprises a first inner wall and a first outer wall connected between the first top wall and the first bottom wall; the first inner wall is located inside the first outer wall for enclosing and forming a first assembly space, and the first assembly space is configured to assemble the receiving optical element; and the first top wall is provided with a third through hole communicating with the first assembly space, and the first bottom wall is provided with a fourth through hole communicating with the first assembly space; and
the first inner wall surface also comprises a first connecting part, the first connecting part is located at a side of the first sealing part farther away from the light-transmitting sheet; the first lens barrel enters the first accommodating space via the second through hole, a side of the first outer wall closer to the light-transmitting sheet is connected to the first connecting part; and a side of the first optical element closer to the light-transmitting sheet goes beyond the first assembly space via the third through hole, is exposed to the first accommodating space and is hermetically connected to the first sealing part.

7. The laser ranging device according to claim 6, wherein the first inner wall comprises a first bearing part formed by extending towards proximity to an interior of the first assembly space; the first bearing part is annular for bearing the first optical element; the first bearing part has a third sealing groove arranged in a full circle; and the third sealing groove is filled with a third sealing rubber ring so that the first optical element and the first inner wall are hermetically connected to each other.

8. The laser ranging device according to claim 3, wherein the first inner wall surface also comprises a first light-blocking part, and the first light-blocking part is connected to an end of the first sealing part closer to the light-transmitting sheet; an angle range covered by a space formed by enclosure of the first light-blocking part matches a receiving angle of view of the laser receiving module; and at least a portion of a wall surface of the first light-blocking part is provided with a first light-blocking groove.

9. The laser ranging device according to claim 1, wherein: the laser emission module comprises the second enclosing member; the second enclosing member comprises a second inner wall surface, a third end surface, and a fourth end surface; the second inner wall surface encloses and forms a second accommodating space, at least a portion of the second optical element is exposed to the second accommodating space; the third end surface is connected to an end of the second inner wall surface closer to the light-transmitting sheet and has a fifth through hole communicating with the second accommodating space; and the fourth end surface is connected to an end of the second inner wall surface farther away from the light-transmitting sheet and has a sixth through hole communicating with the second accommodating space; and
the third end surface is hermetically connected to the light-transmitting sheet, and the second inner wall surface is hermetically connected to the portion of the second optical element exposed to the second accommodating space to form the second sealing cavity between the light-transmitting sheet and the second optical element.

10. The laser ranging device according to claim 9, wherein the third end surface has a second sealing path thereon, and the second sealing path surrounds the fifth through hole and is hermetically connected to the light-transmitting sheet; and/or
wherein the second inner wall surface comprises a second sealing part, and the second sealing part is arranged around the portion of the second optical element exposed to the second accommodating space and hermetically connected to the portion of the second optical element exposed to the second accommodating space.

11. The laser ranging device according to claim 10, wherein:
the third end surface has the second sealing path thereon; and the laser receiving module also comprises a third sealing connecting structure so that the second sealing path and the light-transmitting sheet are hermetically connected to each other; and
the third sealing connecting structure comprises a fourth sealing bulge, a fourth sealing groove, and a fourth sealing rubber ring; the fourth sealing bulge is arranged on the third end surface and along the second sealing path, the fourth sealing groove is arranged on the first light-transmitting surface of the light-transmitting sheet closer to the laser emission module, or the fourth sealing groove is arranged on the third end surface and along the second sealing path, the fourth sealing bulge is provided on the first light-transmitting surface of the light-transmitting sheet closer to the laser emission module; and the fourth sealing bulge is embedded into the fourth sealing groove and hermetically connected to the fourth sealing groove via the fourth sealing rubber ring; or
the third sealing connecting structure comprises a third welding connecting structure, and the third welding connecting structure is formed after the third end surface and the light-transmitting sheet are welded along the second sealing path.

12. The laser ranging device according to claim 10, wherein: the second inner wall surface comprises the second sealing part, and the laser emission module also comprises a fourth sealing connecting structure so that the second sealing part and the portion of the second optical element exposed to the second accommodating space are hermetically connected to each other; and
the fourth sealing connecting structure comprises a fifth sealing groove and a fifth sealing rubber ring; the second optical element comprises a second outgoing surface closer to the light-transmitting sheet and a second sidewall connected to the second outgoing surface; the portion of the second optical element exposed to the second accommodating space comprises the second outgoing surface and an end of the second sidewall closer to the light-transmitting sheet; the second sealing part and the end of the second sidewall closer to the light-transmitting sheet are enclosed to form the fifth sealing groove; and the fifth sealing rubber ring is filled in the fifth sealing groove.

13. The laser ranging device according to claim 10, wherein:
the emission lens module also comprises a second lens barrel; the second lens barrel comprises a second top wall and a second bottom wall arranged opposite to each other, and also comprises a second inner wall and a second outer wall connected between the second top wall and the second bottom wall; the second inner wall is located inside the second outer wall for enclosing and forming a second assembly space, the second assembly space is configured to assemble the emission optical element; and the second top wall is provided with a seventh through hole communicating with the second assembly space, and the second bottom wall is provided with an eighth through hole communicating with the first assembly space; and
the second inner wall surface also comprises a second connecting part, the second connecting part is located at a side of the second sealing part farther away from the light-transmitting sheet; the second lens barrel enters the second accommodating space via the sixth through hole, a side of the second outer wall closer to the light-transmitting sheet is connected to the second connecting part; and a side of the second optical element closer to the light-transmitting sheet goes beyond the second assembly space via the seventh through hole, is exposed to the second accommodating space and is hermetically connected to the first sealing part.

14. The laser ranging device according to claim 13, wherein the second inner wall comprises a second bearing part formed by extending towards proximity to an interior of the second assembly space; the second bearing part is annular for bearing the second optical element; the second bearing part has a sixth sealing groove arranged in a full circle; and the sixth sealing groove is filled with a sixth sealing rubber ring so that the second optical element and the second inner wall are hermetically connected to each other.

15. The laser ranging device according to claim 10, wherein the second inner wall surface also comprises a second light-blocking part, the second light-blocking part is connected to an end of the second sealing part closer to the light-transmitting sheet; an angle range covered by a space formed by enclosure of the second light-blocking part matches an emission angle of view of the laser emission module; and at least a portion of a wall surface of the second light-blocking part is provided with a second light-blocking groove.

16. The laser ranging device according to claim 1, wherein:
the light-transmitting sheet has a first engaging edge, and the housing has a second engaging edge thereon; and the light-transmitting sheet and the housing form the accommodating cavity after the first engaging edge and the second engaging edge are hermetically connected; and
the first engaging edge is formed with a first connecting bulge, the second engaging edge is formed with a first connecting groove, and the first connecting bulge is embedded into the first connecting groove and hermetically connected to the first connecting groove via a seventh sealing rubber ring filled in the first connecting groove; or the first engaging edge is formed with the first connecting groove, the second engaging edge is formed with the first connecting bulge, and the first connecting bulge is embedded into the first connecting groove and hermetically connected to the first connecting groove via the seventh sealing rubber ring filled in the first connecting groove.

17. The laser ranging device according to claim 16, wherein:
the housing comprises a first housing and a second housing connected to the first housing, the first housing comprises a first plate surface facing the light-transmitting sheet, and the second engaging edge is provided on the first plate surface;
the first housing also comprises a second plate surface, the second plate surface has a third engaging edge thereon; the second housing has a fourth engaging edge thereon; and the third engaging edge and the fourth engaging edge, when hermetically connected, together define an internal accommodating space of the housing;
the third engaging edge is formed with a second connecting groove thereon, the fourth engaging edge is formed with a second connecting bulge thereon, the second connecting bulge is embedded into the second connecting groove and hermetically connected to the second connecting groove via an eighth sealing rubber ring filled within the first connecting groove, or the third engaging edge is formed with the second connecting groove thereon, the fourth engaging edge is formed with the second connecting bulge thereon, the second connecting bulge is embedded into the second connecting groove and hermetically connected to the second connecting groove via the eighth sealing rubber ring filled within the second connecting groove; and
the first housing is further provided with a first mounting hole thereon, and the first mounting hole passes through the first plate surface and the second plate surface for mounting the receiving lens module; and the first housing is further provided with a second mounting hole, and the second mounting hole passes through the first plate surface and the second plate surface for mounting the emission lens module.

18. The laser ranging device according to claim 1, wherein: the light-transmitting sheet comprises a first light-transmitting sheet and a second light-transmitting sheet; the receiving lens module is provided between the laser detector and the first light-transmitting sheet; and the emission lens module is provided between the laser and the second light-transmitting sheet; and
the laser receiving module comprises the first enclosing member, the first enclosing member is arranged between the first optical element and the light-transmitting sheet, has one end hermetically connected to the first light-transmitting sheet, and has the other end hermetically connected to the first optical element to enclose and form the first sealing cavity between the first light-transmitting sheet and the first optical element; and the laser emission module also comprises the second enclosing member, the second enclosing member is provided between the second optical element and the light-transmitting sheet, has one end hermetically connected to the second light-transmitting sheet, and has the other end hermetically connected to the second optical element to enclose and form the second sealing cavity between the second light-transmitting sheet and the second optical element.
